(19) United States
(12) Patent Application Publication
(10) Pub. No.: US 2008/0055883 A1
(43) Pub. Date: Mar. 6, 2008

(54) SURFACE-TREATED SURFACE LIGHT SOURCE, METHOD OF FABRICATING THE SAME, AND BACKLIGHT UNIT HAVING THE SAME

(75) Inventors: Ki Yeon Lee, Suwon-si (KR); Kyeong Taek Jung, Suwon-si (KR); Hyung Bin Youn, Suwon-si (KR); Keun Seok Lee, Suwon-si (KR); Dong Hee Lee, Suwon-si (KR); Seok Mo Ban, Suwon-si (KR); Sergey K. Evstropiev, Suwon-si (KR); Kang Min Kim, Suwon-si (KR); Tae Ho Park, Suwon-si (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Samsung Corning Co., Ltd., Suwon-si (KR)

(21) Appl. No.: 11/897,247

(22) Filed: Aug. 29, 2007

(30) Foreign Application Priority Data
Aug. 30, 2006 (KR) 10-2006-0083094
Nov. 6, 2006 (KR) 10-2006-0109015

(51) Int. Cl. H01J 1/62; F21V 9/16; H01J 9/00

(52) U.S. Cl. 362/84; 313/491; 445/26

(57) ABSTRACT

A surface treatment layer containing alkali metal oxide is formed on at least one of substrates to form a body of a surface light source. The surface treatment layer may be formed of oxide by coating at least one of cesium, potassium, rubidium, and compound thereof on the surface of the substrate and by performing heat treatment to the substrate. The surface treatment layer containing alkali metal oxide easily emits secondary electrons and reduces firing voltage of the surface light source. Black start is improved, discharging efficiency is increased, and heat generated during the operation is decreased.

### CROSS-REFERENCE TO RELATED APPLICATIONS

This application claims priority from Korean Patent Application No. 10-2006-0083094 filed in the Korean Intellectual Property Office on Aug. 30, 2006 and Korean Patent Application No. 10-2006-0109015 filed in the Korean Intellectual Property Office on Nov. 6, 2006; the entire contents of which are incorporated herein by reference.

### BACKGROUND OF THE INVENTION

1. Technical Field

The present invention relates to a surface light source, a method of fabricating the same, and a backlight unit having the same, and more particularly, to a surface light source having a surface-treated layer with excellent secondary electron emission.

2. Discussion of Related Art

A liquid crystal display displays an image, using the electrical and optical properties of liquid crystal. The liquid crystal display is widely employed in portable computers, communication devices, liquid crystal television receivers, aerospace industry, and the like because volume and weight are smaller and lighter than those of a cathode ray tube (CRT).

The liquid crystal display includes a controlling unit to control a liquid crystal panel and a backlight source to illuminate the liquid crystal panel. The controlling unit includes pixel electrodes arranged on a first substrate, a common electrode disposed on a second substrate, and the liquid crystal panel disposed between the pixel electrodes and the common electrode. The number of the pixel electrodes is plural to achieve a resolution of the liquid crystal display, and the common electrode is single and faces the pixel electrodes. Thin film transistors (TFT) are connected to the pixel electrodes to apply voltages of different levels thereto and a reference voltage of the same level is applied to the common electrode. The pixel electrodes and the common electrode are made of a transparent conductive material.

The light illuminated by the backlight source passes through the pixel electrodes, the liquid crystal panel, and the common electrode sequentially. In this case, the quality of an image transmitted through the liquid crystal panel significantly depends on luminance of and luminance uniformity of the backlight source. Generally, as the luminance and the uniformity of luminance are high, the image quality becomes high.

The backlight source of a conventional liquid crystal display chiefly employs a bar-shaped cold cathode fluorescent lamp (CCFL) or a dot-shaped light emitting diode (LED). The cold cathode fluorescent lamp has high luminance and long lifespan and generates less heat than that of an incandescent lamp. On the other hand, The LED has high power consumption, but has excellent luminance. However, the CCFL and the LED are disadvantageous of inferior uniformity of the luminance. Thus, in order to increase the uniformity of luminance, the backlight source employing the CCFL or LED as a light source requires optical members, such as a light guide panel (LGP), a diffusion member, and a prism sheet. Due to the optical members, the liquid crystal display employing the aforementioned CCFL or LED significantly increases in size and in weight.

A flat fluorescent lamp (FFL) has been proposed as the backlight source of the liquid crystal display.

The flat fluorescent lamp has problems such that a stabilizing time of the luminance is long at a starting time at low temperature and the uniformity of luminance is inferior due to own temperature deviation caused by a sensibility of mercury with respect to temperature. There are additional problems to be solved for the big-sized flat light source.

### SUMMARY OF THE INVENTION

Therefore, the present invention is directed to provide a new surface light source suitable for a large-sized liquid crystal display.

Another object of the present invention is to provide a surface light source having a low firing voltage and a short luminance stabilization time.

In accordance with an aspect of the present invention, the present invention provides a surface light source comprising a first substrate, a second substrate spaced from the first substrate by a predetermined distance to form an inner discharging space in association with the first substrate, an electrode unit to apply a discharging voltage to the inner discharging space, and

a surface treatment layer made of alkali ions and/or alkali metal oxide formed on at least one of the first substrate and the second substrate.

The surface treatment layer comprises at least one of cesium oxide, potassium oxide, and rubidium oxide.

At least one spacer may be inserted between the first substrate and the second substrate so that the first substrate and the second substrate are spaced apart from each other by a predetermined distance. The inner space defined by the first and second substrates may form a single open discharging space, which is sealed and isolated from the exterior. Otherwise, a plurality of barrier parts may be arranged between the first and second substrates, which partition the inner discharging space defined by the first and second substrates into a plurality of individual regions. Further, at least one of the first substrate and the second substrate may be made in the form of a meander shape such that the inner discharging space is partitioned into a plurality of individual regions

In accordance with another aspect of the present invention, the present invention provides a method of manufacturing a surface light source comprising preparing a first substrate and a second substrate, forming a surface treatment layer containing alkali ions or compound thereof on at least one surface of the first substrate and the second substrate, forming a sealed discharging space by bonding the first substrate to the second substrate, and forming an electrode unit on the first substrate and the second substrate.

The forming of a surface treatment layer may comprise coating material containing alkali metal or compound thereof on at least one surface of the first substrate and the second substrate, and performing heat treatment to the substrates to form an alkali metal oxide layer.

The forming of a surface treatment layer may comprise preparing a liquid solution, for example alkali metal compound, coating the liquid solution on the at least one surface of the first substrate and the second substrate, and performing heat treatment to the coated substrate within temperature of 400 degrees centigrade to 700 degrees centigrade after drying the coated substrate. The liquid solution may comprise at least one of Mg, La, Sc, Al, B, Y, Eu, and Ba in order to improve optical property of a surface-treated glass substrate.

According to the present invention, the glass substrate for a surface light source includes a surface treatment layer with a thickness equal to or less then 20 μm on the surface and alkali metal ions and/or oxide compound thereof is uniformly distributed in the surface treatment layer. The concentration of the alkali metal ions is maximized in the surface of the glass substrate.

According to the present invention, chemical reaction between alkali metal ions and an oxide in the glass substrate may provide roughness on the surface of the glass substrate.

According to the present invention, the secondary electron emission property is improved by change of the chemical composition and morphology of the surface treatment layer of the glass substrate. Moreover, the secondary electron emission material process is carried out during the surface light source manufacturing process so that high concentration of the secondary electron emission material can be maintained.

In accordance with another aspect of the present invention, the present invention provides a backlight unit comprising a surface light source including a sealed discharging space formed by a first substrate and a second substrate; an electrode unit to apply a discharging voltage to the first substrate and the second substrate; and a surface treatment layer containing alkali metal oxide formed on at least one surface of the first substrate and the second substrate; a case to accommodate the surface light source; and an inverter to apply a voltage to the electrode unit.

In the surface light source and the backlight unit according to the present invention, a surface treatment layer including alkali metal ions and/or the oxides thereof is formed on the surface of a substrate so that the secondary electrons are easily emitted, the firing voltage can be reduced, and black start can be improved, emission efficiency can be improved, and heat can be reduced during the driving thereof.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a surface light source according to an embodiment of the present invention;

FIG. 2 is a sectional view taken along the line X-X′ in FIG. 1;

FIG. 3 is a sectional view taken along the line Y-Y′ in FIG. 1;

FIG. 4 is a sectional view schematically illustrating a substrate on which a surface treatment layer is formed;

FIG. 5 is a graph illustrating concentration of Cs ions when an additional heat treatment is carried out;

FIG. 6 is a graph illustrating secondary electron emission property of a substrate including the surface treatment layer;

FIG. 7 is a perspective view illustrating a surface light source according to another embodiment of the present invention;

FIG. 8 is a side view illustrating the surface light source in FIG. 7;

FIG. 9 is a sectional view illustrating a surface-treated substrate;

FIG. 10 is a partially-enlarged view of a portion “S” in FIG. 9;

FIG. 11 is a sectional view illustrating a surface-treated substrate including an additional layer;

FIG. 12 is a sectional view taken along the line Z-Z′ in FIG. 7;

FIG. 13 is a partially-enlarged view of a portion ‘A’ in FIG. 12;

FIG. 14 is a sectional view illustrating a multilayer electrode unit employed in embodiments of the present invention;

FIGS. 15 to 17 are plan views illustrating various patterns of the electrode unit of the surface light source according to embodiments of the present invention; and

FIG. 18 is an exploded perspective view illustrating a backlight unit including the surface light source according to embodiments of the present invention.

### DETAILED DESCRIPTION OF THE INVENTION

The present invention will now be described more fully hereinafter with reference to the accompanying drawings, in which preferred embodiments of the invention are shown.

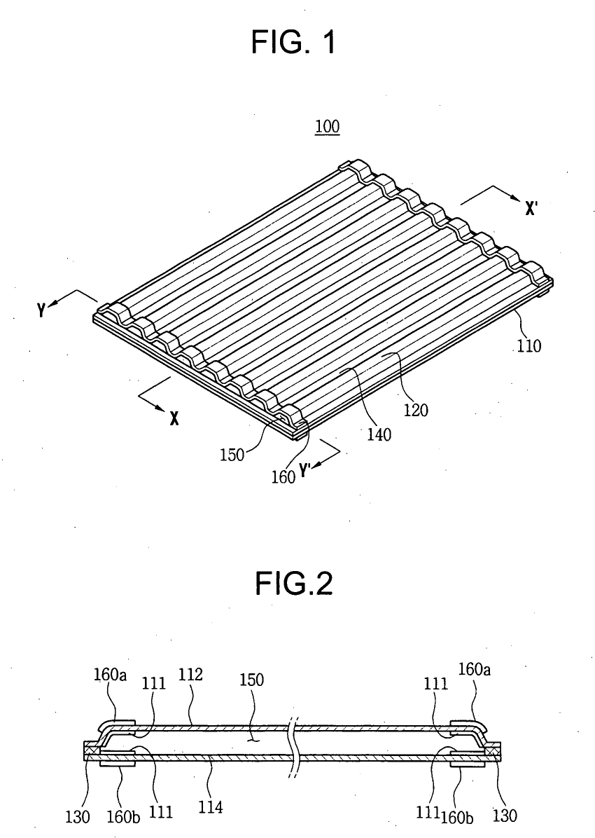

FIG. 1 is a perspective view illustrating a surface light source 100 according to an embodiment of the present invention, and the surface light source 100 includes a light source body 110 and an electrode unit 160 provided at the lateral rim of the light source body 110.

The light source body 110 includes a first substrate 112 and a second substrate 114 which are spaced apart from each other by a predetermined distance. A plurality of barrier parts 140 are arranged between the first and second substrates 112 and 114, and partition a space defined by the first and second substrates 112 and 114 into a plurality of discharging channels 120. The discharging channels 120 and the barrier parts 140, for example, may be formed in the first substrate 112, or may be formed in the second substrate 114 in addition to or in spite of the first substrate 112. Between the rims of the first and second substrates 112 and 114, sealing members 130 are disposed to isolate the discharging channels 120 from the exterior. A discharging gas is injected into the discharging spaces 150 in the discharging channels 120. Although not depicted in the drawing, fluorescent layers and protection layers may be formed in the discharging channels 120 and one of the first and second substrates 112 and 114 may be formed with a reflective layer.

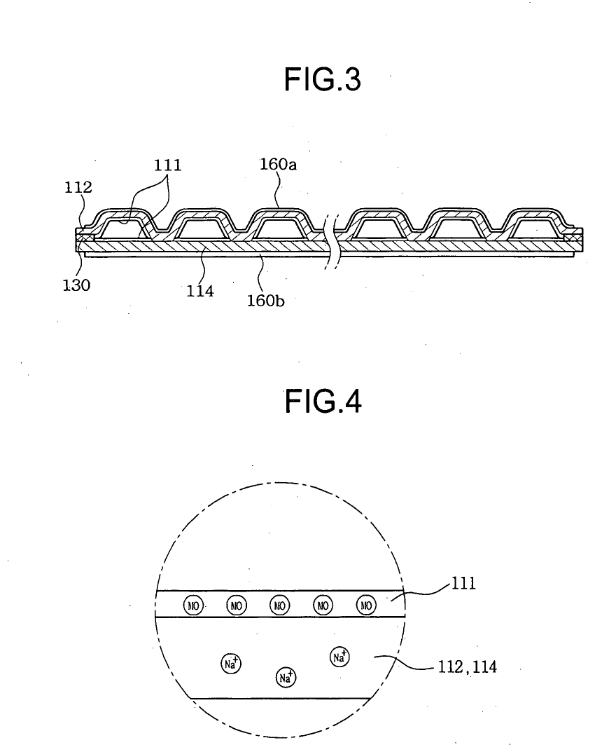

Referring to FIGS. 2 and 3, as sectional views respectively taken along the line X-X′ and the line Y-Y′ in FIG. 1, the surface light source in this embodiment of the present invention includes a surface treatment layer 111 additionally formed on the surface of the first substrate 112 or the second substrate 114. The surface treatment layer 111 contains material from which secondary electrons are easily emitted, and the material is preferably an oxide.

FIG. 4 schematically illustrates the first and second substrates 112 and 114 on which the surface treatment layers 111 are formed, and the surface treatment layers 111 contain alkali metal oxide such as cesium (Cs), potassium (K), rubidium (Rb), and the like. The alkali metal oxide layer may be made by various methods such as a physical deposit method of sputtering a fabricated target. In the present invention, the alkali metal oxide layer is preferably made by a coating method in order to simplify a manufacturing process and to be easily formed on the large-sized substrate. In more detail, compound containing alkali metal is coated on the surface of the substrate in the wet method and fine structures of a coating layer that is formed on the surface of the substrate is transformed into oxide by heat treatment. Temperature for the heat treatment is determined within a range of not influencing the substrate, and thus, the fine structures of the surface treatment layer can be changed by heating, for example, about 300 degrees centigrade.

CsSO₄, CsI, KI, and RbI may be used as a starting material for coating the alkali metal on the substrate. The starting material that is mixed with an organic or inorganic solvent is coated on the surface of the substrate, and have undergone the heat treatment so that the surface treatment layer from which unnecessary material is removed can be obtained in the form of the oxide.

Moreover, in the present invention, the surface treatment layer may be formed by thermochemically processing a glass substrate using a compound containing Cs, K, and Rb during the surface light source manufacturing process.

An example of forming the surface treatment layer using Cs compound during the surface light source manufacturing process will be described. First, the Cs compound is melted into methanol to make a dilute solution for cesium nitride, cesium hydroxide, and cesium chloride. The Cs compound contents of all the solutions are 1.0 wt %. In order to improve roughness of the coating layer, a very small quantity of polyvinyllidone (0.5 wt %) is added as a surfactant.

The solution is sprayed on the surface of the glass substrate for manufacturing a fluorescent lamp at normal temperature. Alumina and a multi-component fluorescent layer are formed in the glass substrate as a reflective layer. After the drying of the glass substrate, the glass substrate on which the coating layer is formed is heated at 560 degrees centigrade during the surface light source manufacturing process. In the glass substrate in which the coating layer is formed using the cesium nitride and the cesium chloride, residual material is removed from the glass substrate after the heat treatment.

The surface light source is made of the glass substrate. Gas mixture of Xe and Ne (Xe/Ne=4) is filled in a lamp at a gas pressure of 500 Torr and a voltage of about 100 V is applied to the lamp.

Examples of the firing voltage and luminance of the lamp are measured and listed in Table 1. It can be understood that the firing voltage of the surface light source can be remarkably decreased by the thermochemical process to the glass substrate of the surface light source. The firing voltages are decreased in samples (lamps 3 to 6 and 11 to 14) from which the coating residual material is removed after the heat treatment and in other samples (lamps 7 to 10) in which the coating residual material remains. On the other hand, although the Cs coating layer is formed on the glass substrate, the luminance is not remarkably deteriorated.

TABLE 1
Luminance and firing voltage of a surface
light source with a coating layer

| | | |
|---|---|---|
| | | firing voltage |
| coating solution | luminance (nit) | (kV) |

| | | | |
|---|---|---|---|
| Uncoated | lamp 1 | 10230 | 2.18 |
| | lamp 2 | 8605 | 2.14 |
| CsNO₃ | lamp 3 | 10040 | 2.01 |
| | lamp 4 | 10580 | 2.07 |
| | lamp 5 | 10600 | 1.99 |
| | lamp 6 | 10430 | 1.98 |
| CsOH | lamp 7 | 10310 | 1.71 |
| | lamp 8 | 10620 | 1.74 |
| | lamp 9 | 10500 | 1.71 |
| | lamp 10 | 9150 | 1.75 |
| CsCl | lamp 11 | 10340 | 2.08 |
| | lamp 12 | 10010 | 2.14 |
| | lamp 13 | 10310 | 2.07 |
| | lamp 14 | 10010 | 2.04 |

As such, when the thermochemical process is carried out on the surface of the glass substrate during the surface light source manufacturing process, manufacturing costs of the lamps is decreased and thermal history happening in the glass substrate is mitigated so that resistance for the thermal shock and physical durability of the lamps can be increased. Moreover, the coating layer and other coating layers formed on the inner and outer surfaces of the lamps may be sequentially formed so that the process efficiency can be improved.

Moreover, the Cs coating layer is formed during the lamp manufacturing process so that a high concentration of Cs ions can be maintained in the surface of the glass substrate and the secondary electron emission can be increased from the lamps. In the manufacturing process of the emission device such as the fluorescent lamp, in order to use the glass substrate containing the secondary electron emission material, at least two heat treatment processes are required: one is for forming the secondary electron emission material on the surface of the glass substrate and the other is an additional plastic process for the glass substrate performed during the lamp manufacturing process. With the repetition of the heat treatments, the glass substrate is repeatedly between high temperature and low temperature so that the thermal history happens. Further, a coated material is formed on the glass substrate, and an additional process of removing the residual coated material must be carried out. Thus, the process becomes complicated and economic efficiency of the manufacturing process is poor.

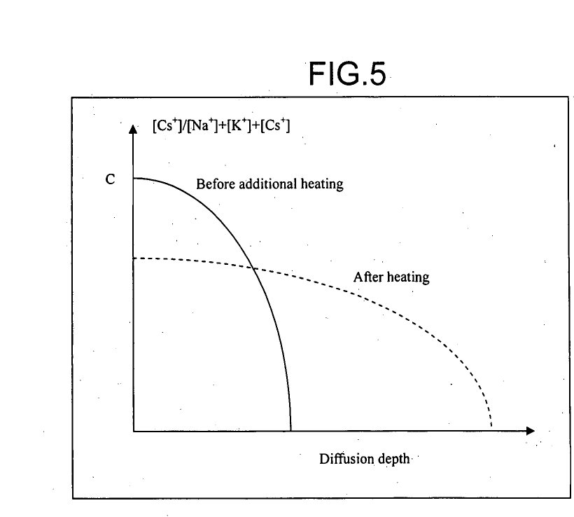

Furthermore, when the glass substrate containing the secondary electron emission material undergoes an additional heat treatment during the lamp manufacturing process, the secondary electron emission material is diffused deep into the glass substrate and as a result, the concentration of the secondary electron emission material on the surface of the glass substrate may be rapidly decreased. Referring to FIG. 5, in a case when there is no additional heat treatment during the lamp manufacturing process, the Cs ions are concentrated on the surface of the glass substrate on which the Cs coating layer is formed and the concentration Cs thereof is very high. However, it is understood that the Cs ions are diffused deep into the glass substrate after the additional heat treatment during the lamp manufacturing process so that the concentration of the secondary electron emission material in the surface of the glass substrate is significantly decreased.

In the present invention, the Cs ions are contained in the glass substrate during the surface light source manufacturing process so that high concentration of Cs can be maintained in the surface of the glass substrate, and thus stable and effective secondary electron emission can be expected. Therefore, the operation property of the lamp can be improved.

The thermochemical process of the surface of the glass substrate carried out in the present invention, may be performed during the surface light source manufacturing process. For example, the thermochemical process may be performed before and after the forming of the coating layer on the glass substrate, before the bonding of glass substrates, and before and after a plastic process of the glass substrate.

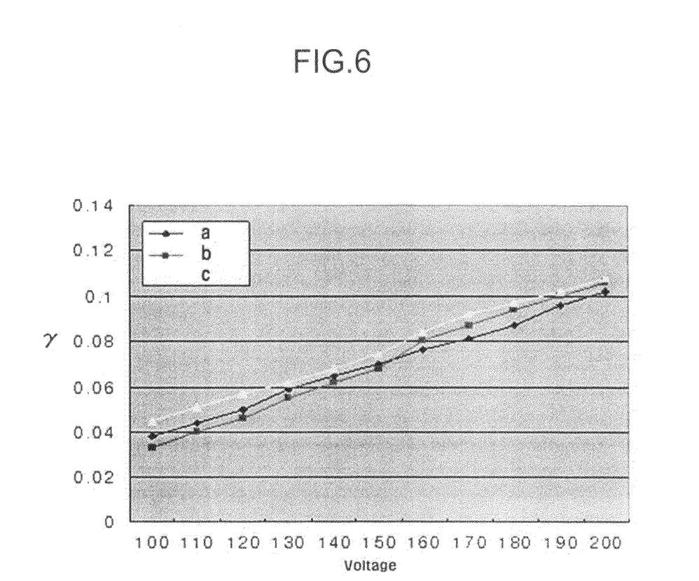

FIG. 6 is a graph illustrating the secondary electron emission property of the surface-treated substrate. In comparison to a substrate a without surface treatment, in a substrate b in which K oxide is formed using KI as a starting material and a substrate c in which the Cs oxide is formed using CsI as a starting material, the secondary electron emission coefficient γ is excellent at a range (accelerating voltages of 180 eV to 200 eV) relating a driving voltage of the surface light source.

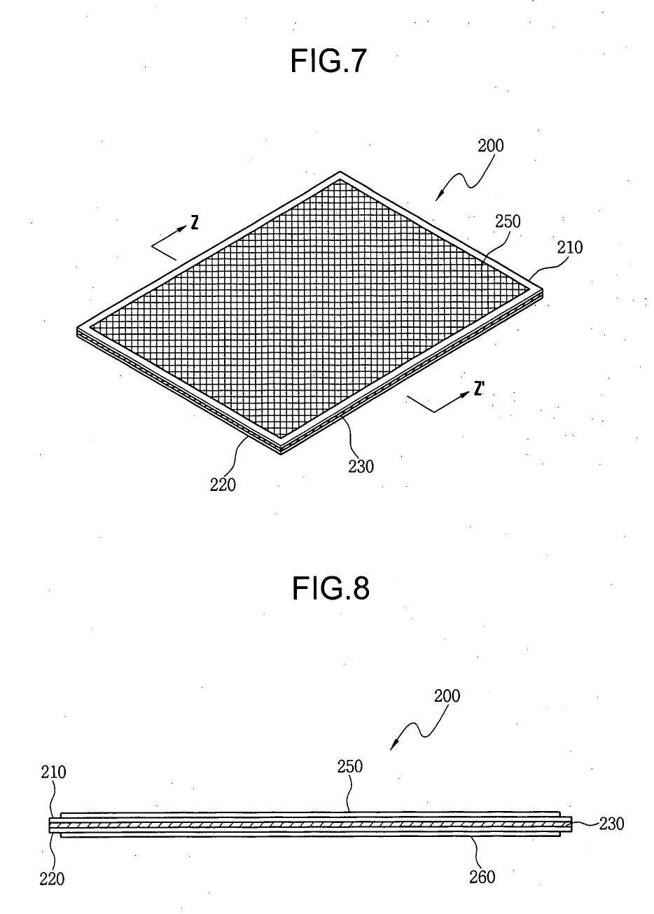

FIG. 7 is a perspective view illustrating a surface light source 200 according to another embodiment of the present invention, and FIG. 8 is a side view illustrating the surface light source 200 in FIG. 7.

The surface light source 200 includes first and second flat substrates 210 and 220 with the same shape. Preferably, the first substrate 210 and the second substrate 220 are transparent thin glass substrates. There is no restriction for the thickness of the first and second substrates 210 and 220, but the first and second substrates 210 and 220 have a thickness of about 1 mm to 2 mm, preferably equal to or less than 1 mm.

Fluorescent layers are coated on the inner surfaces of the first and second substrates 210 and 220, and a reflective layer may be further formed on one of the first and second substrates 210 and 220. The first and second substrates 210 and 220 face each other and are spaced by a predetermined distance. A sealing member 230 such as frit or a sidewall is inserted between rims of the first and second substrates 210 and 220 to form a closed space between the first and second substrates 210 and 220.

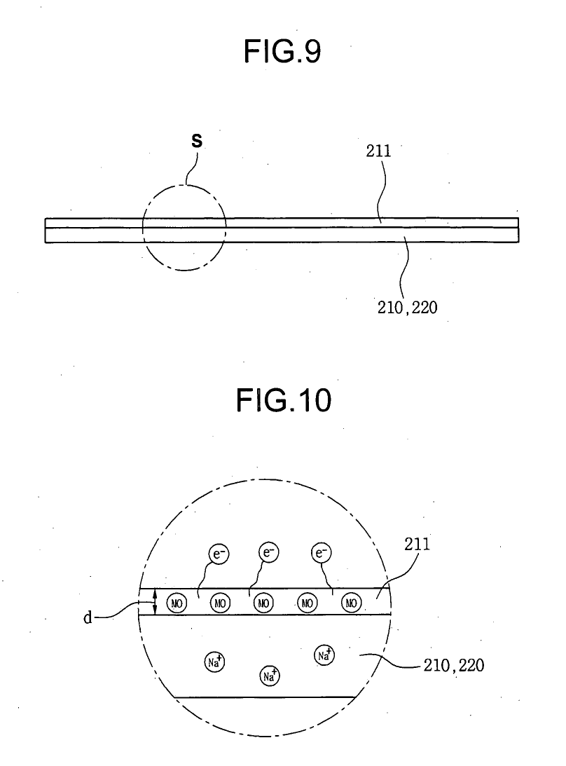

A surface treatment layer 211 is formed, as illustrated in FIG. 9, on the surface of the first or second substrate 210 or 220. The surface treatment layer is made in such a way that material containing the above-mentioned alkali metal is formed on the surfaces of the substrates 210 and 220 of sodalime glass to emit the secondary electrons easily. Solution containing the alkali metal is coated on the surface of the substrate to form the surface treatment layer with about 1 μm to 20 μm on the surface through the exchange with alkali ions (for example, Na ions) in the substrate. The surface treatment layer 211, as illustrated in the enlarged view of FIG. 10, preferably presents in the form of metal oxide MO. To this end, there is a plastic process of plastically deforming the substrates at a predetermined temperature. The surface treatment layer 211 that is changed into the oxide presents on the surface of the substrate in more stable state. The alkali metal that has permeated the substrate as ions initially is crystallized by the plastic process and forms a surface treatment layer of a minute structure.

The secondary electrons are emitted from the surface treatment layer 211 during the operation of the surface light source so that the electrical discharge vigorously occurs in the inner space of the substrates. As a result, the firing voltage is reduced and radiation efficiency is improved. Moreover, heat generated during the operation is reduced so that stability of the surface light source increases.

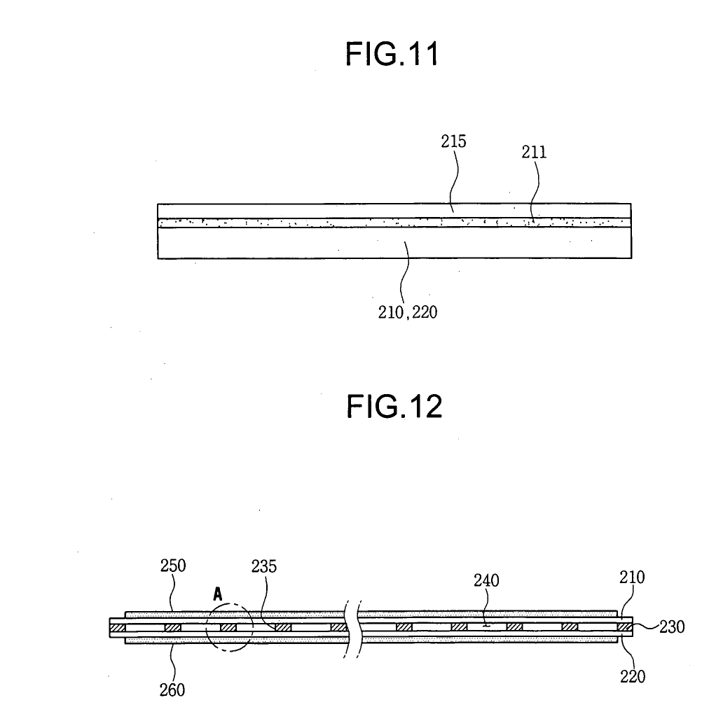

The surface treatment layers 211 are formed on the surfaces of the first and second substrates 210 and 220 and an additional layer 215 such as the fluorescent layer and/or the reflective layer as illustrated in FIG. 11 may be formed thereon.

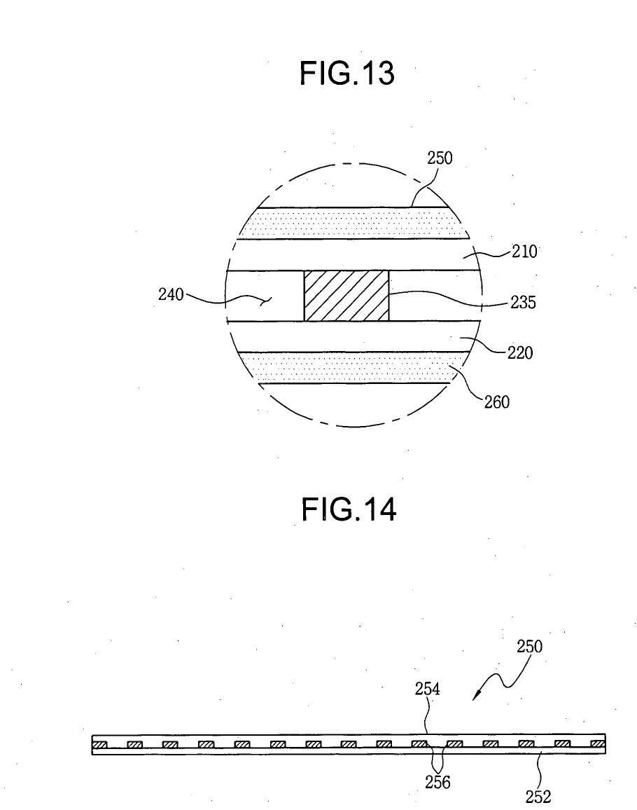

In the surface light source according to another embodiment of the present invention, a large-area flat electrode is formed on the outer surface of the light source body that is formed by the first and second substrates 210 and 220. FIG. 12 is a sectional view taken along the line Z-Z′ in FIG. 7 and FIG. 13 is a partially-enlarged view of a portion ‘A’ in FIG. 12. As illustrated, a first surface electrode 250 and a second surface electrode 260 are formed on the outer surfaces of the first and second substrates 210 and 220, respectively. The first and second surface electrodes 250 and 260 are formed in the form of a flat surface electrode to substantially cover entire areas of the substrates.

At least one of the first and second surface electrodes 250 and 260 preferably has an aperture ratio equal to or higher than 60%, to open the substrates in order to increase transmittance of light emitted from the light source body due to the discharge.

The first and second substrates 210 and 220 are preferably flat substrates. The inner space defined by the first and second substrates and a sealing member is not an individual discharging space partitioned by a partition like the conventional surface light source, but a single open discharging space 240. The distance between the first and second substrates 210 and 220 is relatively small in comparison to the areas of the substrates 210 and 220 and the inner space forms the single open structure so that exhaustion for forming vacuum state and injection of the discharging gas are very easy. Moreover, in addition to mercury, xenon, argon, neon, and other inactive gas or gas mixture thereof are used as the discharging gas so that the first and second substrates 210 and 220 are suitable to construct the surface light source.

The height of discharging space 240 formed between the first and second substrates 210 and 220 may be determined by a spacer 234. The number and distance of the space 235 may be determined within a range not to deteriorate the luminance property of the light emitted from the surface light source. In another embodiment, the upper substrate may be partially deformed to serve the function of a spacer. Unlikely, the height of the discharging space 240 may be defined by protrusion (not shown) integrally formed with the inner surface of the first or second substrate 210 or 220.

In the surface light source according to this embodiment of the present invention, the first surface electrode 250 and the second surface electrode 260 may employ transparent electrodes such as indium tin oxide (ITO) or other electrodes with predetermined patterns. FIG. 14 is a sectional view illustrating a multilayer electrode unit employed in an embodiment of the present invention. As illustrated, the multilayer electrode unit has a multilayer structure having a lower base layer 252, an electrode pattern 256 formed on the base layer 252, and a protection layer 254 formed on the base layer 252 and the electrode pattern 256. Preferably, the base layer 252 and the protection layer 256 have permeability against visible light.

In an electrode unit having only the electrode pattern, it is difficult to bond the electrode unit to the glass substrate and durability would be inferior. On the other hand, in the multilayer electrode unit, the electrode unit is easily bonded to the substrate, durability of the electrode pattern is guaranteed, and various electrode patterns can be formed.

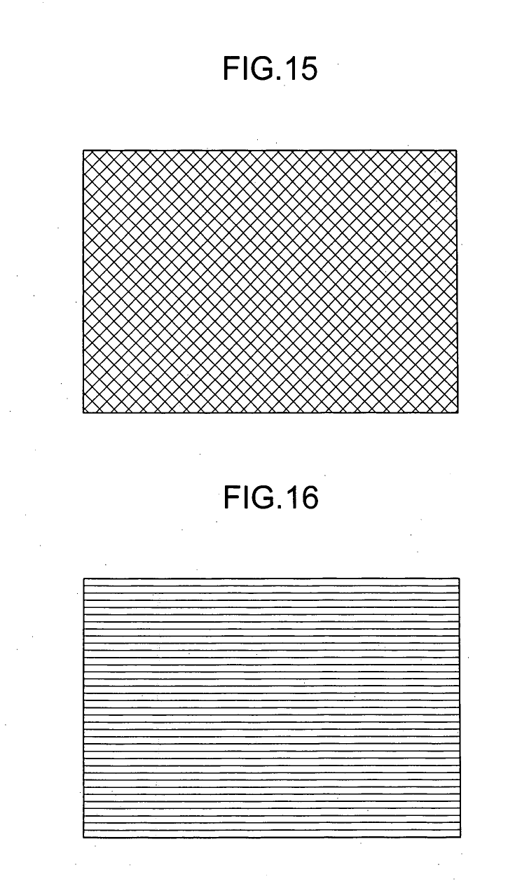

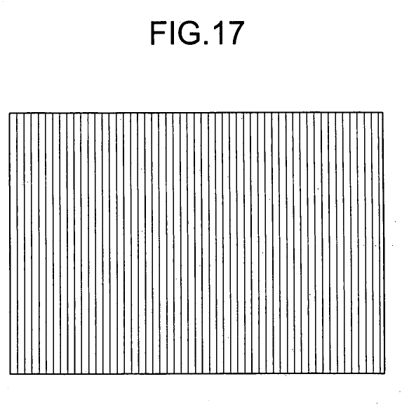

Various patterns may be applied to the flat electrode employed in the surface light source according to this embodiment of the present invention. For example, a net type pattern as illustrated in FIG. 15, a stripe type pattern as illustrated in FIGS. 16 and 17 may be available. The patterns of the first and second surface electrodes 250 and 260, which are respectively formed on the first and second substrates 210 and 220, are different from each other so that may change the discharging property of the surface light source.

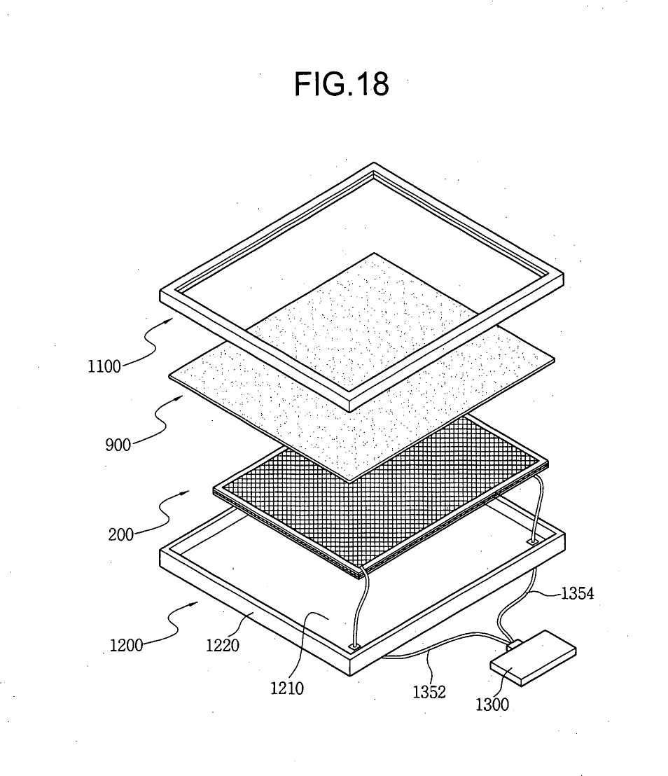

FIG. 18 is an exploded perspective view illustrating a backlight unit including the surface light source according to an embodiment of the present invention. As illustrated, the backlight unit includes a surface light source 200, upper and lower cases 1100 and 1200, an optical sheet 900, and an inverter 1300. The lower case 1200 includes a bottom 1210 to support the surface light source 200 and a plurality of sidewalls 1220 extending from edges of the bottom 1210 to form an accommodating space. The surface light source 200 is accommodated in the accommodating space of the lower case 1200.

The inverter 1300 is disposed on the rear side of the lower case 1200 and generates a discharging voltage to drive the surface light source 200. The discharging voltage generated by the inverter 1300 is applied to the electrodes of the surface light source 200 via first and second power lines 1352 and 1354, respectively. The optical sheet 900 may include a diffusion plate to uniformly diffuse light emitted from the surface light source 200 and a prism sheet to make the diffused light go straight ahead. The upper case 1100 is coupled with the lower case 1200 to support the surface light source 200 and the optical sheet 900. The upper case 1100 prevents the surface light source 200 from being separated from the lower case 1200.

Unlike the drawing as illustrated, the upper case 1100 and the lower case 1200 may be formed in the form of a single integrated case. Meanwhile, the backlight unit may not include the optical sheet 900 because luminance of and luminance uniformity of the surface light source according to the present invention are excellent.

Since the surface light source and the backlight unit according to the present invention include the surface treatment layers containing the alkali metal oxide, the secondary electrons are easily emitted, the firing voltage is reduced, and the black start is improved. Particularly, the secondary electron emitting layer is easily formed so that manufacturing costs can be reduced and it is advantageous in mass production.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A surface light source comprising:
a first substrate;
a second substrate spaced from the first substrate by a predetermined distance to form an inner discharging space in association with the first substrate;
an electrode unit to apply a discharging voltage to the inner discharging space; and
a surface treatment layer made of alkali metal ions and/or alkali metal oxide formed on at least one of the first substrate and the second substrate.

2. The surface light source of claim 1, wherein the alkali metal oxide comprises at least one of cesium oxide, potassium oxide, and rubidium oxide.

3. The surface light source of claim 1, wherein the surface treatment layer has a thickness of 1 micrometer to 20 micrometers.

4. The surface light source of claim 1, wherein the surface treatment layer is made by ion exchange in which alkali ions of the first substrate or the second substrate are exchanged with other alkali material.

5. The surface light source of claim 1, wherein the electrode unit comprises a flat surface electrode formed on at least one entire surface of the first substrate and the second substrate.

6. The surface light source of claim 1, wherein at least one of the first substrate and the second substrate is made in the form of a meander shape such that the inner discharging space is partitioned into a plurality of individual regions.

7. A method of manufacturing a surface light source comprising:
forming a surface treatment layer containing alkali metal ions and/or alkali metal oxide on at least one surface of a first substrate and a second substrate;
forming a sealed discharging space by bonding the first substrate to the second substrate; and
forming an electrode unit on the first substrate and the second substrate.

8. The method of manufacturing a surface light source of claim 7, wherein the forming of a surface treatment layer comprises:
coating material containing alkali metal on at least one surface of the first substrate and the second substrate; and
performing heat treatment to the substrates to form an alkali metal oxide layer.

9. The method of manufacturing a surface light source of claim 7, wherein the forming of a surface treatment layer comprises:
preparing a liquid solution of Cs compound;
coating the liquid solution on the at least one surface of the first substrate and the second substrate; and
performing heat treatment to the coated substrate within temperature of 400 degrees centigrade to 700 degrees centigrade after drying the coated substrate.

10. The method of manufacturing a surface light source of claim 9, wherein the liquid solution comprises at least one of Mg, La, Sc, Al, B, Y, Eu, and Ba.

11. The method of manufacturing a surface light source of claim 9, wherein the liquid solution comprises surfactant.

12. A backlight unit comprising:
a surface light source including a first substrate, and a second substrate at least partially spaced from the first substrate; a discharging space formed between the first substrate and the second substrate; an electrode unit to apply a discharging voltage to the first substrate and the second substrate; and a surface treatment layer containing alkali metal oxide formed on at least one surface of the first substrate and the second substrate;
a case to accommodate the surface light source; and
an inverter to apply a voltage to the electrode unit.

13. The thin backlight unit of claim 12, wherein the surface treatment layer comprises at least one of cesium oxide, potassium oxide, and rubidium oxide
